(19) United States
(12) Patent Application Publication
(10) Pub. No.: US 2020/0173130 A1
(43) Pub. Date: Jun. 4, 2020

(54) OFFSHORE STATION AND METHOD FOR FLUSHING SHELTERED REGIONS

(71) Applicant: INNOGY SE, 45128 Essen (DE)

(72) Inventor: Thorsten SCHLÜTER, Barmstedt (DE)

(73) Assignee: INNOGY SE, 45128 Essen (DE)

(21) Appl. No.: 16/622,285

(22) PCT Filed: Jun. 11, 2018
(86) PCT No.: PCT/EP2018/065278

§ 371 Date: Dec. 12, 2019

(30) Foreign Application Priority Data
Jun. 14, 2017 (DE) 10 2017 113 189.2

(51) Int. Cl. E02B 17/00; E02B 17/02; F03D 80/55; B08B 9/00

(52) U.S. Cl. CPC E02B 17/0034; E02B 17/027; E01C 9/008; B08B 9/00; F03D 80/55

(57) ABSTRACT

Offshore station, having a metal structure, wherein the metal structure (4) has watering regions (6) which are exposed to natural watering (22), wherein the metal structure (4) has sheltered regions (8) which are exposed to natural watering (22) only to a limited extent, if at all, having at least one cleaning device (14), wherein the cleaning device (14) has at least one collecting device (16), at least one line system (18) and outlet openings (20), wherein the collecting device (16) is designed for collecting rainwater (22), wherein the line system (18) is connected to the collecting device (16) and is designed for distributing the rainwater (22), and wherein the outlet openings (20) are designed for flushing the sheltered regions (8) with rainwater (22).

### RELATED APPLICATIONS

This Application is a § 371 National Stage Application of PCT/EP2018/065278, filed Jun. 11, 2018, which claims priority benefit of German Patent Application No. 102017113189.2, filed Jun. 14, 2017, which applications are incorporated entirely by reference herein for all purposes.

### FIELD

The invention relates to an offshore station and a method for flushing sheltered regions of an offshore station.

### BACKGROUND ART

Offshore stations are often constructed from metal over multiple decks. The metal used is usually protected against corrosion by being coated. Because the saline offshore atmosphere has an increased chloride content, after the chlorides have been acting for a certain period of time corrosion appears on the metal of the offshore station even when there is a high degree of corrosion protection.

An elevated concentration of chlorides can occur in particular in gap or edge regions, metal chlorides being formed by the metal ions which are discharged. These metal chlorides react in the next step with water to form metal hydroxide and hydrochloric acid. The acids lower the pH, as a result of which the corrosion reaction is accelerated.

The corrosion can proceed in an intensified fashion in regions of the offshore station which are not exposed to rainfall or only to a limited extent and accordingly are not sufficiently washed or flushed. For this reason, such sheltered regions in which corrosion occurs in an intensified fashion are regularly washed or flushed with fresh water by maintenance staff. The flushing accordingly takes place manually at fixed intervals, wherein maintenance staff rinse the corresponding regions with the aid of cleaning apparatus. The manual maintenance is time- and cost-intensive and, owing to the limited ability to reach certain regions, cannot be performed reliably in all sheltered regions and with the required regularity.

### SUMMARY OF THE INVENTION

Starting from the above described prior art, the invention is based on the problem of providing an offshore station and a method for flushing sheltered regions which do not have the above described disadvantages or at least to a reduced extent and in particular enable reduced corrosion on sheltered regions of an offshore station.

The above described technical problem is solved by an offshore station as claimed in claim 1 and a method as claimed in claim 9. Further embodiments of the invention emerge from the dependent claims and the following description.

According to a first aspect, the invention relates to an offshore station with a metal structure, wherein the metal structure has rained-on regions which are exposed to rainfall, wherein the metal structure has sheltered regions which are not exposed to rainfall or only to a limited extent, with at least one cleaning device, wherein the cleaning device has at least one accumulation device, at least one conduit system, and outlet openings, wherein the accumulation device is configured to collect rainwater, wherein the conduit system is connected to the accumulation device and is configured to distribute the rainwater, and wherein the outlet openings are configured for flushing the sheltered regions with rainwater.

An automated and/or simultaneous and/or autonomous flushing of sheltered regions can take place in particular with the aid of the cleaning device. It can thus be achieved that all the sheltered regions which are critical for the occurrence of corrosion are flushed regularly. In addition, the maintenance costs can be reduced. The flushing events can be performed independently of whether maintenance teams are available. The conduits of the cleaning device can run in sheltered regions which cannot be reached by maintenance staff or only with difficulty.

Sheltered regions can in particular be formed by the offshore station having multiple superposed decks, wherein the lower decks are partially or completely spanned or sheltered by the upper decks situated above them.

The offshore station can be an offshore substation for a wind turbine. The offshore substation serves to transform and export the energy obtained by one or more wind turbines.

The offshore can alternatively be a station which is constructed on a ship such as, for example, a container ship or the like.

According to an embodiment of the offshore station, it is provided that the cleaning device has at least one filter and/or at least one oil/water separator and/or at least one water treatment device in order to treat the collected rainwater before flushing the sheltered regions. It can thus be ensured that no contaminated water is used or that only water of sufficient quality is released into the environment for flushing purposes.

The outlet openings can be formed on nozzles, in particular on sprinkler nozzles. With the aid of the nozzles, the rainwater can be distributed over a large area and/or applied in a targeted fashion to surfaces of the sheltered regions which are to be flushed. Reliable flushing of the sheltered regions can thus be achieved.

One or more pumps can be provided for conveying the rainwater to the outlet openings. In particular, the pumps can be configured to supply a predetermined pressure in the conduit system. A predetermined pressure can, for example, be set in order to convey the rainwater reliably through nozzles at which the outlet openings for ejecting the rainwater are formed.

The conduit system can have pipes and/or hoses, the circumferential surface of which can have outlet openings for ejecting the rainwater. Alternatively or additionally to nozzles, the outlet openings can accordingly be an integral constituent of the pipes and/or hoses of the conduit system. A wide range of outlet openings can thus be provided simply and cost-effectively.

Hoses or pipes can, for example, be provided which have slits on their periphery. Applying pressure to the inside of the inner circumferential surface of the hose or pipe in the region of the slits causes the hose or pipe to be widened reversibly in the region of the slits in such a way that the rainwater emerges from the hose or tube and can be applied to adjacent or surrounding sheltered regions. The rainwater can be conveyed through the hose, for example, by pumps at a predetermined pressure in order to widen the slits of the hose or pipe and allow the rainwater to escape.

According to a further embodiment of the offshore station, it can be provided that the cleaning device has a control system for controlling flushing events, wherein the control system in particular has a rain sensor and/or a timer and/or a fill-level sensor and/or a camera. Flushing events or flushing intervals can be controlled autonomously by means of the control system.

According to a further embodiment, the offshore station has a helipad, wherein the helipad forms a collecting area of the accumulation device for collecting rainwater. By virtue of its exposed position and large open area, such a helipad is particularly well suited as a collecting area from which rainwater can, for example, be guided to a storage space or conducted directly to the sheltered regions and uses for flushing purposes.

The accumulation device can have a storage space for storing 2 m³ to 20 m³ of rainwater. The size of the storage space can be configured as a function of the amount of rain which is usually expected and of the size of the areas of the sheltered regions which are to be flushed. The accumulation device can in particular have a storage space of 3 m³ to 10 m³.

The cleaning device is in particular structurally and functionally separate and independent from an extinguisher system or fire-prevention system which may be provided on the offshore station.

According to a second aspect, the invention relates to a method for flushing sheltered regions of an offshore station, having the method steps:

collecting and accumulating rainwater using an accumulation device for collecting rainwater;

distributing the rainwater using a conduit system connected to the accumulation device and feeding the rainwater to outlet openings;

flushing the sheltered regions with rainwater via the outlet openings.

An automated and/or simultaneous and/or autonomous flushing of sheltered regions can take place in particular with the aid of the method. It can thus be achieved that all the sheltered regions which are critical for the occurrence of corrosion are flushed regularly. In addition, the maintenance costs can be reduced. The flushing events can be performed independently of whether maintenance teams are available. The conduits of the cleaning device can run in sheltered regions which cannot be reached by maintenance staff or only with difficulty.

The method according to the invention can be performed using an offshore station according to the invention which has already been described above.

According to an embodiment of the method, it can be provided that the rainwater is treated and/or quality-controlled and/or filtered before the sheltered regions are flushed. It can thus be ensured that no contaminated water is used and that only water of sufficient quality is released into the environment for flushing purposes.

It can be provided that the sheltered regions are flushed at fixed intervals, in particular every two weeks. Regular cleaning and flushing of the sheltered regions can thus be achieved.

Alternatively or additionally, the sheltered regions can be flushed depending on the fill level of the accumulation device, wherein a minimum fill level of the accumulation device exists in particular before the start of a flushing event. It can therefore be provided that a flushing event only takes place when sufficient water is present for reliably and adequately flushing all sheltered regions.

Alternatively or additionally, flushing of the sheltered regions can take place depending on need, wherein the need for flushing is determined in particular by a camera system which monitors at least partially the sheltered regions to be flushed. An operator can, for example, regularly monitor sheltered regions which are particularly prone to corrosion and may trigger a flushing event. Alternatively or additionally, the camera images can be evaluated by software in order to detect the need for flushing and trigger flushing.

Alternatively or additionally, a flushing event can be triggered manually by an operator. This can take place on site on the offshore station itself or by remote control.

Alternatively or additionally, continuous flushing can take place. It can be provided that sheltered regions are flushed continuously by collected rainwater in order to prevent corrosion.

### BRIEF DESCRIPTION OF THE DRAWINGS

The invention is described below with the aid of drawings illustrating exemplary embodiments, in which:

FIG. 1 shows schematically an offshore station;

FIG. 2 shows schematically an offshore station according to the invention;

FIG. 3 shows schematically a method according to the invention.

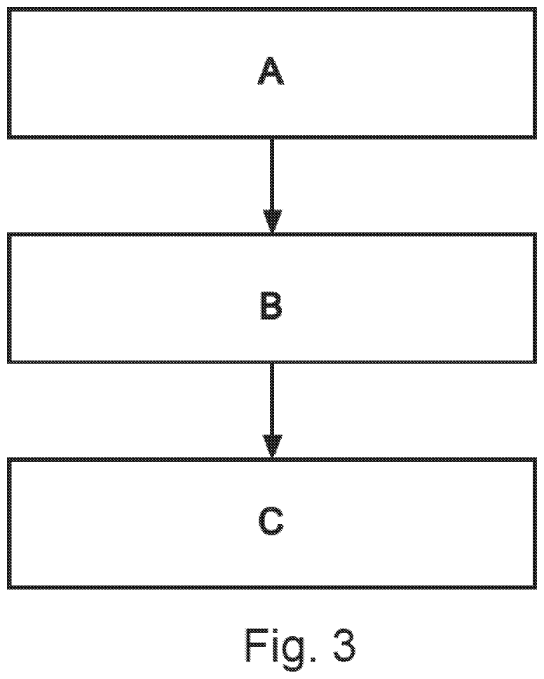

### DETAILED DESCRIPTION OF THE EMBODIMENTS

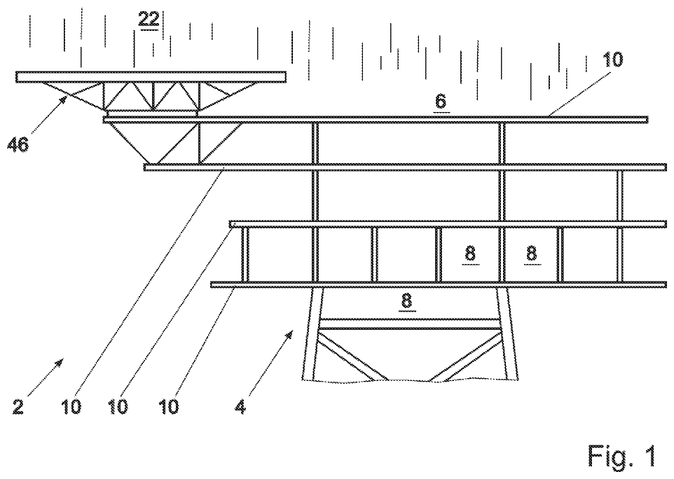

FIG. 1 shows an offshore station 2. The offshore station 2 is an offshore substation 2 of a wind turbine.

The offshore station 2 has a metal structure 4. The metal structure 4 has rained-on regions 6 which are exposed to natural rainfall 22. The metal structure 4 has sheltered regions 8 which are not exposed to natural rainfall 22 or only to a limited extent. Sheltered regions 8 of this type are formed in particular below decks 10 of the offshore station 2. The offshore station 2 has a helipad 46.

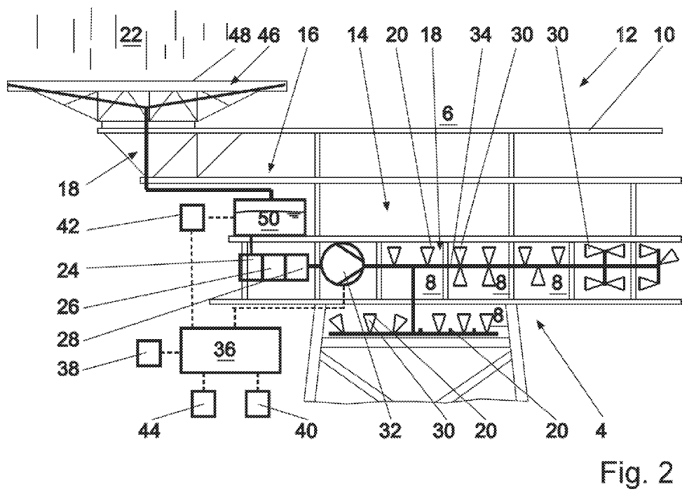

FIG. 2 shows an offshore station 12 according to the invention which, analogously to the offshore station 2, has a metal structure 4, rained-on regions 6, sheltered regions 8, and decks 10.

The offshore station 12 according to FIG. 2 has a cleaning device 14. The cleaning device 14 has an accumulation device 16, a conduit system 18 and outlet openings 20.

The accumulation device 16 is configured to collect rainwater 22. The conduit system 18 is connected to the accumulation device 16 and configured to distribute the rainwater 22. The outlet openings 20 are configured for the purpose of flushing the sheltered regions 8 with rainwater 22.

The cleaning device 14 has a filter 24, an oil/water separator 26, and a water-treatment device 28. They serve to treat the collected rainwater 22 before the sheltered regions 8 are flushed. The water-treatment device 28 can be provided for at least partially desalinating the rainwater 22.

In the present case, the outlet openings 20 are formed on nozzles 30. The nozzles 30 are sprinkler nozzles 30 in the present case.

A pump 32 is furthermore provided for conveying the rainwater 22 to the outlet openings 20. The conduit system 18 has hoses 34 and pipes 34, the circumferential surfaces of which likewise have outlet openings 20 for ejecting the rainwater 22.

The cleaning device 14 has a control system 36 for controlling flushing events. The control system 36 has a rain sensor 38, a timer 40, a fill-level sensor 42, and a camera 44.

The offshore station 12 has a helipad 46. The helipad 46 forms a collecting area 48 of the accumulation device 16 for collecting the rainwater 22.

A storage space 50 of the accumulation device 16 is 15 m³ in the present case.

The method according to the invention is described in detail below.

In a method step A, rainwater 22 is first collected using the accumulation device 16.

In method step B, the rainwater 22 is passed into the storage space 50 via the conduit system 18. Starting from the storage space 50, the rainwater 22 is treated by the filter 24, the oil/water separator 26, and the water-treatment device 28. The rainwater 22 is furthermore distributed via the conduit system 16 and fed to the outlet openings 20.

In a method step C, the sheltered regions 8 are flushed with rainwater 22 via the outlet openings 20.

In the present case, a flushing event is performed every two weeks.

### LIST OF REFERENCE NUMERALS

2 offshore station
4 metal structure
6 rained-on region
8 sheltered region
10 deck
12 offshore station
14 cleaning device
16 accumulation device
18 conduit system
20 outlet opening
22 rainwater
24 filter
26 oil/water separator
28 water-treatment device
30 nozzle/sprinkler nozzle
32 pump
34 hoses/pipes
36 control system
38 rain sensor
40 timer
42 fill-level sensor
44 camera
46 helipad
48 collecting area
50 storage space

1. An offshore substation of a wind turbine, comprising: a metal structure (4),
wherein the metal structure (4) has rained-on regions (6) which are exposed to natural rainwater (22), and
wherein the metal structure (4) has sheltered regions (8) which are not exposed to rainwater or only to a limited extent; and
at least one cleaning device (14),
wherein the cleaning device (14) has at least one accumulation device (16), at least one conduit system (18), and outlet openings (20),
wherein the accumulation device (16) is configured to collect rainwater (22),
wherein the conduit system (18) is connected to the accumulation device (16) and is configured to distribute the rainwater (22), and
wherein the outlet openings (20) are configured for flushing the sheltered regions (8) with rainwater (22).

2. The offshore substation of claim 1, wherein
the cleaning device (14) has at least one filter (24) or at least one oil/water separator (26) or at least one water-treatment device (28), or a combination thereof, in order to treat the collected rainwater (22) before the sheltered regions (8) are flushed.

3. The offshore substation of claim 1, wherein
the outlet openings (20) are formed on nozzles (30), in particular on sprinkler nozzles (30).

4. The offshore substation of claim 1, wherein
one or more pumps (32) are provided for conveying the rainwater (22) to the outlet openings (20).

5. The offshore substation of claim 1, wherein
the conduit system (18) has pipes (34) or hoses (34), or a combination thereof, the circumferential surfaces of which have outlet openings (20) for ejecting the rainwater (22).

6. The offshore substation of claim 1, wherein
the cleaning device (14) has a control system (36) for controlling flushing events, wherein the control system (36) in particular has a rain sensor (38) or a timer (40) or a fill-level sensor (42) and/or a camera (44), or a combination thereof.

7. The offshore substation of claim 1, further comprising:
a helipad (46),
wherein the helipad (46) forms a collecting area (48) of the accumulation device (16) for collecting rainwater (22).

8. The offshore substation of claim 1, wherein
the accumulation device (16) has a storage space (50) for storing 2 m³ to 20 m³ of rainwater (22).

9. A method for flushing sheltered regions of an offshore substation of a wind turbine, comprising:
collecting and accumulating rainwater (22) using an accumulation device (16) for collecting rainwater (22);
distributing the rainwater (22) using a conduit system (18) connected to the accumulation device (16) and feeding the rainwater (22) to outlet openings (20); and
flushing the sheltered regions (8) of the offshore substation of the wind turbine with rainwater (22) via the outlet openings (20).

10. The method of claim 9, wherein
the rainwater (22) is treated and/or quality-controlled and/or filtered before the sheltered regions (8) are flushed.

11. The method of claim 9, wherein
the sheltered regions (8) are flushed at fixed intervals, in particular every two weeks or
the sheltered regions (8) are flushed depending on the fill level of the accumulation device (16), wherein a minimum fill level of the accumulation device (16) exists in particular before the start of a flushing event or
flushing of the sheltered regions (8) takes place depending on need, wherein the need for flushing is determined in particular by a camera system (44) which monitors at least partially the sheltered regions (8) to be flushed or
a flushing event is triggered manually by an operator; or
continuous flushing takes place,
or a combination thereof.
